(19) United States
(12) Patent Application Publication
(10) Pub. No.: US 2025/0095881 A1
(43) Pub. Date: Mar. 20, 2025

(54) ETHERNET CABLE FOR VEHICLE

(71) Applicant: LS CABLE & SYSTEM LTD., Anyang-si, Gyeonggi-do (KR)

(72) Inventors: Woo Kyoung LEE, Suwon-si, Gyeonggi-do (KR); Kyeong Hoon KOOK, Suwon-si, Gyeonggi-do (KR); Jung Pyo HONG, Gumi-si, Gyeongsangbuk-do (KR); Jun LEE, Suwon-si, Gyeonggi-do (KR); Jeong Min SONG, Namyangju-si, Gyeonggi-do (KR)

(21) Appl. No.: 18/729,240

(22) PCT Filed: Feb. 10, 2022
(86) PCT No.: PCT/KR2022/002053

§ 371 Date: Jul. 16, 2024

(51) Int. Cl. H01B 11/08; H01B 3/42; H01B 7/02; H01B 7/18

(52) U.S. Cl. CPC H01B 11/085; H01B 3/423; H01B 7/02; H01B 7/1895

(57) ABSTRACT

The present disclosure relates to an Ethernet cable for a vehicle, which enables large-capacity data communication and high-speed transmission, required in a network system for a vehicle, on the basis of low voltage differential signaling (LVDS), minimizes the overall outer diameter and weight, and has excellent durability against vibration and excellent electrical characteristics.

### CROSS-REFERENCE TO RELATED APPLICATIONS

The present application is a National Stage of International Application No. PCT/KR2022/002053, filed on Feb. 10, 2022, the entire contents of each hereby incorporated by reference.

### FIELD

The present disclosure relates to an Ethernet cable for a vehicle. More specifically, the present disclosure relates to an Ethernet cable for a vehicle that enables large-capacity communication and high-speed transmission required in a network system for a vehicle on the basis of low voltage differential signaling (LVDS), has minimized overall outer diameter and weight, excellent durability against vibration, and excellent electrical characteristics.

### BACKGROUND

Recently, as an information and communication technology (ICT) technology has been converged into vehicles, the network system for a vehicle has been developing into an In-Vehicle infotainment (IVI) system that provides not only communication functions between in-vehicle devices, but also connected car functions, V2X communication, autonomous driving, remote control services, and the like.

Accordingly, the demand for large-capacity processing and high-speed transmission in the network system for a vehicle is further increasing. In this regard, a low voltage differential signaling (LVDS) system method, which can reduce power consumption using a low voltage and is capable of high-speed transmission, may be applied.

This LVDS means a general interface standard for high-speed data transmission, and in particular, Ethernet cable, which has high transmission characteristics, supports a relatively wide bandwidth, has excellent flexibility and heat resistance, and has a relatively low manufacturing cost, is mainly used as a transmission medium for data transmission of various electronic equipment such as in-vehicle lidar sensors, semiconductors, displays, camera modules, and the like.

FIG. 6 illustrates a cross-sectional view of one example of an Ethernet cable for a vehicle that has been introduced in the relate art. As illustrated in FIG. 6, a conventional Ethernet cable 100 for a vehicle′ is configured to include a pair of conductor wires 20 twisted with each other at a twist pitch, including a plurality of wires 21 and an insulator 23 surrounding the entirety of the wires, and an outer jacket 40 surrounding the entirety of the pair of conductor wires 20.

Here, the conventional Ethernet cable 100′ for a vehicle′ requires the installation of a plurality of Ethernet cables 100′ in proportion to types of transmission signals, and is insufficiently prepared for noise caused by mutual effects between cables. Further, the conventional Ethernet cable 100′ for a vehicle′ was not sufficiently durable as a vehicle cable due to the lack of preparation for vibration and shock.

Further, when Ethernet cables such as general UTP cables and STP cables are applied to vehicles, there is a problem that these cables are not designed with electrical characteristics in consideration according to the LVDS standard, which may lead to adverse effects such as malfunction or transmission loss.

In addition, when Ethernet cables such as general UTP cables and STP cables are applied to vehicles, they have a structure that includes four pairs in which eight conductor wires are twisted with a twist pitch of two, in which case four of the eight conductor wires are usually used as a ground or spare function, causing a problem of unnecessary waste of resources and increasing costs.

To solve these problems, there is a high demand for an Ethernet cable for a vehicle that enables large-capacity communication and high-speed transmission required by a network system for a vehicle on the basis of low voltage differential signaling (LVDS), has minimized overall weight, and has excellent electrical characteristics such as durability against vibration, attenuation, and near end crosstalk.

### SUMMARY

The present disclosure is directed to providing an Ethernet cable for a vehicle that enables large-capacity communication and high-speed transmission required in a network system for a vehicle on the basis of low voltage differential signaling (LVDS), has minimized overall outer diameter and weight, excellent durability against vibration, and excellent electrical characteristics.

To solve the aforementioned objects, the present disclosure is directed to providing an Ethernet cable for a vehicle including. The Ethernet cable may include: a filler member; four conductor wires disposed around the filler member and configured to include a plurality of wires having a total sum of cross-sectional areas of 0.15 to 0.17 millimeters (mm²) and an insulator surrounding the plurality of wires; a shielding layer surrounding the four conductor wires; and an outer jacket surrounding the shielding layer, in which the four conductor wires may be configured to be assembled together at a collective pitch of 26 to 34 millimeters (mm); and in which the four conductor wires may be configured in pairs of two, each pair of the four conductor wires being capable of transmission for different low voltage differential signaling (LVDS).

Here, the collective pitch of the four conductor wires may be preferably 29 to 31 millimeters (mm).

Here, an attenuation per unit length (m) of the cable for a 50 MHz test signal may be satisfied to be 0.25 dB or less.

In addition, a near end crosstalk over a transmission section of 100 meters (m) of the cable for a 50 MHz test signal may be satisfied to be 50 dB or more.

Here, the plurality of wires constituting the four conductor wires may have an average diameter of 0.16 to 0.18 millimeters (mm).

In this case, each of the four conductor wires may be configured with seven wires, in which the seven wires may be configured such that one wire is disposed in the center and six wires are disposed to be circumscribed therearound.

Further, the insulator of the four conductor wires may be configured to have a thickness of 0.3 to 0.6 millimeters (mm) and have a characteristic impedance of 90 to 110 ohms (Q) for a 50 MHz test signal.

In addition, the filler member may be made of at least one material of polyethylene (PE), fluorinated ethylene propylene (FEP), or polyethylene terephthalate (PET), and have an outer diameter of 0.5 to 0.6 millimeters (mm).

Further, each of the four conductor wires may have an outer diameter of 1.3 to 1.7 millimeters (mm).

Here, the cable may have an outer diameter of 4.5 to 6.0 millimeters (mm).

In addition, the Ethernet cable may further include a shielding layer surrounding the four conductor wires, in which the shielding layer may include an aluminum mylar (Al-mylar) tape layer.

In this case, the shielding layer may include a braided layer configured to include at least one of tinned copper or carbon fiber surrounding the aluminum mylar (Al-mylar) tape layer.

Further, the aluminum mylar (Al-mylar) tape layer constituting the shielding layer may be cross-wound in a direction different from a collective direction of the four conductor wires.

In this case, the Ethernet cable may further include an outer jacket surrounding the shielding layer.

According to the Ethernet cable for a vehicle of the present disclosure, it is possible to minimize signal and power losses by adjusting the collective pitch of four conductor wires, thereby enabling large-capacity data communication and high-speed transmission required in a network system for a vehicle on the basis of low voltage differential signaling (LVDS).

In addition, according to the Ethernet cable for a vehicle of the present disclosure, it is possible to reduce manufacturing costs of the cable by adjusting the cross-sectional areas (mm²) of the plurality of wires constituting each of the four conductor wires to minimize the amount of conductors used, and it is possible to improve energy efficiency and internal space efficiency of the vehicle by minimizing the overall outer diameter and weight of the cable.

In addition, according to the Ethernet cable for a vehicle of the present disclosure, it is possible to improve resistance to vehicle vibration by disposing the filler member in the center, and to maintain roundness, thereby improving overall cable durability.

In addition, according to the Ethernet cable for a vehicle of the present disclosure, the return loss among the electrical characteristics can be improved by the collective direction of the four conductor wires being configured differently from the cross-winding direction of the shielding layer, so that the impedance matching of the Ethernet cable can be implemented smoothly even in a high-speed transmission environment.

### BRIEF DESCRIPTION OF THE DRAWINGS

FIG. 1 illustrates a multi-stage stripped perspective view of an Ethernet cable for a vehicle according to the present disclosure.

FIG. 2 illustrates a cross-sectional view of the Ethernet cable for a vehicle according to the present disclosure.

FIG. 3 illustrates a graph of measurement results of attenuation and near end crosstalk by wire diameter according to a collective pitch of four conductor wires constituting the Ethernet cable for a vehicle according to the present disclosure.

FIG. 4 illustrates a graph of measured return loss when an aluminum mylar tape layer of the Ethernet cable for a vehicle according to the present disclosure is cross-wound in a direction different from a collective direction of the four conductor wires.

FIG. 5 illustrates a graph of measured return loss when the aluminum mylar tape layer of the Ethernet cable for a vehicle according to the present disclosure is cross-wound in a direction identical to the collective direction of the four conductor wires.

FIG. 6 illustrates a cross-sectional view of a conventional Ethernet cable for a vehicle.

### DETAILED DESCRIPTION

Hereinafter, exemplary embodiments of the present disclosure will be described in detail with reference to the accompanying drawings. However, the present disclosure is not limited to the exemplary embodiments to be described below and may be specified as other aspects. On the contrary, the embodiments introduced herein are provided to make the disclosed content thorough and complete, and sufficiently transfer the spirit of the present disclosure to those skilled in the art. Like reference numerals indicate like constituent elements throughout the specification.

Recently, according to the spread of an in-vehicle infotainment (IVI) system in a network for a vehicle, functions, which are from satellite navigation to more recently connected car functions, V2X communication, autonomous traveling, remote control of services, and the like, have been provided.

To implement these in-vehicle infotainment functions, the sensors, radars, or cameras mounted inside the vehicle and the communication cables for a vehicle installed inside the vehicle to connect these to a central processing unit (ECU, etc.) are also increasing significantly. This cable for a vehicle requires the application of a cable capable of high-speed communication because the size of transmission data is larger than the conventional one.

In such environments requiring high-speed data transmission in the vehicle, the low voltage differential signaling (LVDS) method may be applied, which uses high-speed analog circuit technology to support high bandwidth and gigabit-level data transmission at low voltages. In particular, since a main power supply voltage for a vehicle uses a relatively low voltage of DC 12 V or DC 24 V, the application of LVDS has technical and economic advantages in building the network system for a vehicle.

Meanwhile, the low voltage differential signaling (LVDS) is an interface standard for high-speed data transmission, and the Ethernet cable used as a transmission medium for LVDS needs to have small signal attenuation to maintain sufficient voltage and waveform to transmit data, and be configured to minimize electro-magnetic interference (EMI) between other adjacent Ethernet cables or internal conductor wires.

In addition, the Ethernet cable for a vehicle, which is connected to various electronic components inside the vehicle, is increasingly used. Therefore, the Ethernet cable for a vehicle needs to be reduced in weight to minimize an increase in the load of the vehicle, and also secure sufficient durability as a cable for a vehicle. In addition, it is required to minimize mutual effects such as noise between adjacent cables and the like.

Therefore, the present disclosure is directed to providing an Ethernet cable for a vehicle that is configured to facilitate large-capacity communication and high-speed transmission required in a network system for a vehicle on the basis of low voltage differential signaling (LVDS), while having a minimized overall outer diameter and weight, and securing sufficient durability and good shielding performance.

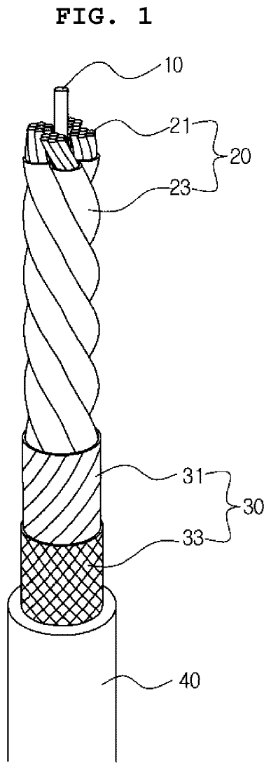

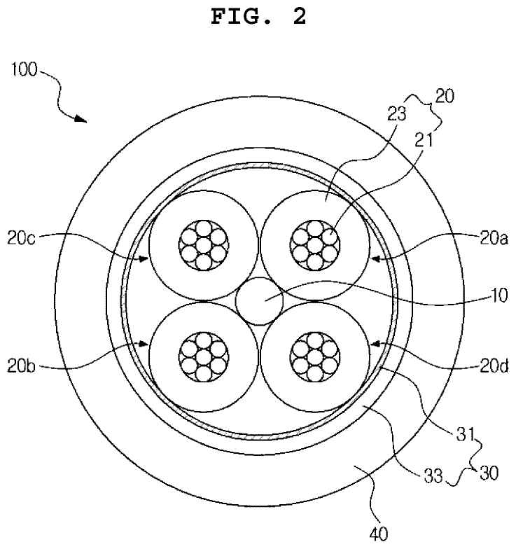

FIG. 1 illustrates a multi-stage stripped perspective view of an Ethernet cable for a vehicle according to the present disclosure, and FIG. 2 illustrates a cross-sectional view of the Ethernet cable for a vehicle according to the present disclosure.

As illustrated in FIGS. 1 and 2, an Ethernet cable 100 for a vehicle according to the present disclosure may include: a filler member 10; four conductor wires 20 disposed around the filler member 10, and configured to include a plurality of wires 21 having a total sum of cross-sectional areas of 0.15 to 0.17 mm², and an insulator 23 surrounding the plurality of wires 21; a shielding layer 30 surrounding the four conductor wires; and an outer jacket 40 surrounding the shielding layer, in which the four conductor wires 20 may be configured to be assembled together at a collective pitch of 26 to 34 millimeters (mm); and in which the four conductor wires 20 are configured in pairs of two, each pair of the four conductor 20 being capable of transmission for different low voltage differential signaling (LVDS).

The Ethernet cable 100 for a vehicle according to the present disclosure has a single filler member 10 disposed at a center, in which the filler member 10 performs serving to maintain an arrangement of four conductor wires 20 disposed around the filler member 10 to maintain roundness of the cable, and to protect the four conductor wires 20 during the installation of the Ethernet cable 100 or against mechanical vibration or other external forces of the vehicle.

The filler member 10 may be made of various polymer resins, for example, polyethylene (PE), fluorinated ethylene propylene (FEP), polyethylene terephthalate (PET), polyvinyl chloride (PVC), polypropylene (PP), and the like, and preferably at least one of polyethylene (PE), fluorinated ethylene propylene (FEP), or polyethylene terephthalate (PET). Here, when the filler member 10 is made of a polyethylene terephthalate (PET) material, the filler member 10 may be configured to have a relatively high hardness, thereby minimizing or preventing the phenomenon of stretching of the filler member 10 when the cable is manufactured.

An outer diameter of the filler member 10 may be configured to be 0.5 to 0.6 millimeters (mm), and when the outer diameter of the filler member 10 is less than 0.5 millimeters (mm), there is a problem that the filler member 10 stretches or breaks due to an external force, in contrast, when the outer diameter of the filler member 10 is greater than 0.6 millimeters (mm), the outer diameter of the filler member 10 becomes excessively large, thereby unnecessarily increasing 1 outer diameter and weight of the cable.

The Ethernet cable 100 for a vehicle according to the present disclosure may be configured to include four conductor wires 20 responsible for a signal transmission function in the vehicle, in which the four conductor wires 20 may be disposed to be circumscribed around the filler member 10 to minimize the outer diameter of the cable.

Here, the four conductor wires 20 may be configured in two pairs, each pair consisting of two conductor wires, each of which may be responsible for transmission for different low voltage differential signaling (LVDS). Specifically, the four conductor wires 20 may be configured in two pairs, each pair consisting of two conductor wires 20a, 20b and 20c, 20d arranged opposite each other with respect to the centrally disposed filler member 10. Each pair may be connected to respective connector terminals connected to the electrical components of the vehicle to perform a communication function.

With this configuration, since the Ethernet cable 100 for a vehicle of the present disclosure is capable of using all four conductor wires 20 for transmitting data, it is possible to omit conductor wires having a ground or spare function, such as a general UTP cable, thereby preventing unnecessary enlargement of the outer diameter of the cable. In addition, the Ethernet cable 100 for a vehicle has the advantage of enabling a larger capacity data transmission than when using a conventional Ethernet cable for a vehicle that is configured to include one pair of conductor wires, and also has the advantage of reducing the number of cables installed inside the vehicle, thereby facilitating maintenance such as cable wiring organization.

The four conductor wires 20 may be configured as a stranded conductor that includes the plurality of wires 21 having a total sum of cross-sectional areas (mm²) of 0.15 to 0.17 mm². Here, the total sum of cross-sectional areas (mm²) of the plurality of wires 21 is precisely adjusted to be satisfied with an attenuation of 0.25 dB or less per unit length (m) of the Ethernet cable 100 for a 50 MHz test signal.

Here, attenuation is a value that is measured by how much of the magnitude of a signal traveling along a cable is lost and weakened upon being transmitted a predetermined distance, and it may be understood to have greater transmission capability than a cable with a higher attenuation characteristic when the cable has a lower attenuation characteristic.

Further, as the total sum of cross-sectional areas (mm²) of the plurality of wires 21 constituting each of the four conductor wires 20 becomes larger, the resistance of signals and power flowing inside the conductor wires 20 is reduced, thereby improving the attenuation characteristics.

When the total sum of cross-sectional areas (mm²) of the plurality of wires 21 is less than 0.15 mm², the attenuation characteristics of the cable are greatly reduced, and when the total sum of cross-sectional areas (mm²) of the plurality of wires 21 is greater than 0.17 mm², the attenuation characteristics of the cable may be improved, but there is a problem that the content of conductors in the cable increases excessively, resulting in high manufacturing costs and an increase in the weight and outer diameter of the cable.

Preferably, each of the four conductor wires 20 may be configured with seven wires 21, and the seven wires 21 may be configured such that one wire is in the center and six wires are disposed to be circumscribed therearound. With this configuration, each of the seven wires 21 constituting each of the four conductor wires 20 may be configured to have an average diameter (mm) of 0.16 to 0.18 millimeters (mm) so that the total sum of cross-sectional areas of the seven wires 21 maintains a range of 0.15 to 0.17 mm².

Each of the four conductor wires 20 is a stranded conductor in which a plurality of wires 21 are assembled together at a predetermined pitch, and this configuration of stranded wires has excellent banding characteristics, facilitating installation in a complex in-vehicle electrical space and having excellent durability.

The plurality of wires 21 constituting each of the four conductor wires 20 may be made of metallic materials such as copper, aluminum, silver, and the like, or alloys thereof, which have low resistance and thus good conductivity.

The insulator 23 may be configured by extrusion or the like of an insulating composition including a polymer resin having electrical insulating characteristics as a base resin, and the polymer resin may be made of a material, for example, but not particularly limited to, polypropylene (PP) and the like, provided that the electrical insulating characteristics may be implemented.

Meanwhile, in order to stably transmit a signal of a high frequency band using the Ethernet cable 100, it is necessary to adjust a characteristic impedance in accordance with input and output impedances of a device connected to the Ethernet cable. Such adjustment of the characteristic impedance may be achieved, for example, by adjusting a thickness of the insulator 23, permittivity of a material of the insulator 23, permittivity of a material of the filler member 10, and the like, and in particular, a condition range of 90 to 110 ohms (Ω) of the characteristic impedance required for the Ethernet cable 100 for a vehicle of the present disclosure has been satisfied by adjusting the thickness of the insulator 23 by the present inventors.

Specifically, an increase in an outer diameter of the conductor wire 20 as the thickness of the insulator 23 increases tends to sequentially result in a decrease in capacitance, a decrease in attenuation, and an increase in a characteristic impedance value of the cable. In contrast, a decrease in the outer diameter of the conductor wire 20 as the thickness of the insulator 23 decreases tends to result in an increase in capacitance, an increase in attenuation, and a decrease in the characteristic impedance value of the cable.

Accordingly, it was experimentally confirmed that when the thickness of the insulator 23 is formed to be 0.3 to 0.6 millimeters (mm) and the outer diameter of the conductor wire 20 according to the thickness of the insulator 23 is configured to be 1.3 to 1.7 millimeters (mm), the characteristic impedance of the Ethernet cable 100 for a vehicle may be configured to be satisfied to be 90 to 110 ohms (Ω) for a 50 MHz test signal.

It was confirmed that when the collective pitch of the four conductor wires 20 is less than 26 mm, the short collective pitch increases an overall length of the conductor wires 20 to be assembled, which is against reduction in weight, and when the collective pitch of the four conductor wires 20 is greater than 34 mm, the collective pitch is difficult to be maintained due to the resilience of the cable itself, and in particular, a crosstalk attenuation effect between the four conductor wires 20 may be degraded.

Therefore, the Ethernet cable 100 for a vehicle according to the present disclosure may be configured such that the four conductor wires 20 are assembled together at a collective pitch of 26 to 34 millimeters (mm), preferably 29 to 31 millimeters (mm). As described above, when the four conductor wires 20 are assembled together in the aforementioned pitch range, the outer diameter of the four assembled conductor wires 20 may be configured to be 3.4 to 3.8 millimeters (mm).

The shielding layer 30 is a constituent element provided to surround the entirety of the four conductor wires 20, in which the shielding layer 30 performs the function of reflecting or absorbing and thus blocking electromagnetic waves emitted from the four conductor wires 20 to the outside and electromagnetic waves attempting to penetrate inside the Ethernet cable 100 according to the present disclosure from the outside.

The shielding layer 30 may include, for example, an aluminum mylar tape layer 31 that includes one or more aluminum mylar tapes with aluminum foil attached to a polyester film, and/or a braided layer 33 that is configured to include at least one of tin-plated copper or carbon fiber (including metal-plated carbon fiber). When the shielding layer 30 includes both the aluminum mylar tape layer 31 and the braided layer 33, the shielding layer 30 may be disposed in such a structure that the aluminum mylar tape layer 31 is cross-wound to surround the four conductor wires 20, and the braided layer 33 surrounds the aluminum mylar tape layer 31.

Here, a thickness of the aluminum mylar tape layer 31 constituting the shielding layer 30 may be configured to be approximately 0.017 to 0.033 millimeters (mm), and a thickness of the braided layer 33 may be configured to be 0.08 to 0.12 millimeters (mm). When the thickness of the aluminum mylar tape layer 31 and/or the braided layer 33 constituting the shielding layer 30 is formed in the range above, it is possible to suitably block crosstalk between adjacent Ethernet cables and the like, while minimizing an increase in the outer diameter of the Ethernet cable.

Further, one or more aluminum mylar (Al-mylar) tapes constituting the aluminum mylar tape layer 31 may be provided to be cross-wound around the four conductor wires 20 in a direction different from a collective direction of the four conductor wires 20, in which case the electrical characteristics of the Ethernet cable 100 for a vehicle of the present disclosure may be satisfied, a description of which will be described below.

The outer jacket 40 is disposed to surround the shielding layer 30 and performs the function of protecting the four conductor wires 20 from external pressure or impact.

The outer jacket 40 may be configured with various polymer resin materials, such as polypropylene, polyvinyl chloride, polyethylene, and the like, and may be preferably configured by extrusion or the like of a composition that includes a polypropylene resin with excellent heat resistance as a base resin.

A thickness of the outer jacket 40 may be selected within the range of 0.48 to 0.68 millimeters (mm), and when the thickness of the outer jacket 40 is less than 0.48 mm, there may be a problem that the cable is broken or damaged by external friction or flexing. In contrast, when the thickness is greater than 0.68 mm, there is a problem that the flexibility of the cable is reduced and the overall outer diameter of the cable increases. Further, the outer diameter of the Ethernet cable of the present disclosure caused by the thickness of the outer jacket 40 may be 4.5 to 6.0 millimeters (mm).

FIG. 3 illustrates a graph of measuring attenuation and near end crosstalk (NEXT) by wire diameter according to the collective pitch of the four conductor wires 20 constituting the Ethernet cable 100 for a vehicle according to the present disclosure.

As described above, the Ethernet cable 100 for a vehicle according to the present disclosure needs to be satisfied with an attenuation of 0.25 dB or less per unit length (m) for a 50 MHz test signal for stable long-distance communication on the basis of low voltage differential signaling (LVDS).

In the present specification, the attenuation of the Ethernet cable for a vehicle according to the present disclosure is measured with reference to TIA-EIA-644-A, which is defined by the Electronic Industries Association of the United States, and the Open Alliance, which is an Ethernet system standard for a vehicle, and an actual measured value of the attenuation according to the aforementioned measurement method is measured with a negative sign, but an attenuation value measured in the present disclosure is expressed with a positive sign because the standard above indicates a positive sign for the same value.

Here, in the attenuation of the cable, the required attenuation characteristics of the cable may be implemented by adjusting the cross-sectional areas or diameters of a plurality of wires inside the conductor wire 20.

The Ethernet cable 100 for a vehicle of the present disclosure was manufactured as in Comparative Example 1, Example 1 and Comparative Example 2, respectively, according to an average diameter of the seven wires 21 constituting each of the four conductor wires 20 as shown in Table 1 below, and the attenuation per length of 100 meters of each cable according to the collective pitch of the four conductor wires 20 was measured and is illustrated in FIG. 3.

TABLE 1

| | Comparative | | Comparative |
|---|---|---|---|
| | Example 1 | Example 1 | Example 2 |
| Number of wires | 7 | 7 | 7 |
| Average diameter | 0.16 | 0.17 | 0.18 |
| of wires (mm) | | | |
| Total sum of | Approx. 0.141 | Approx. 0.159 | Approx. 0.178 |
| cross-sectional | | | |
| areas of wires | | | |
| (mm²) | | | |

As illustrated in FIG. 3, in Comparative Example 1, the seven wires 21 constituting each of the four conductor wires 20 were configured with a relatively small average diameter of 0.16 mm, so that as the conductor resistance inside the conductor wires 20 increased, the range of the collective pitch to achieve an attenuation of 25 dB or less per 100 meters of cable was formed to be excessively large, making it impossible to manufacture a cable configured with normally assembled conductor wires. In Example 1 and Comparative Example 2, it was confirmed that a minimum collective pitch for achieving an attenuation of 25 dB or less per 100 meters of cable is approximately 17.8 mm and approximately 26.4 mm, respectively. Since the conductor resistance decreases as the cross-sectional area or diameter of the wire constituting the conductor wire 20 increases, it is desirable to increase the diameter of the wire in terms of the attenuation characteristics of the cable. However, the Ethernet cable 100 for a vehicle of the present disclosure is configured to minimize not only the attenuation characteristics of the cable, but also the amount of conductor used, thereby aiming to solve reducing the overall outer diameter and weight of the cable. Accordingly, it was confirmed that the average diameter (mm) of the plurality of wires constituting the conductor wire in the Ethernet cable 100 for a vehicle according to the present disclosure needs to be satisfied with approximately 0.17 millimeters (mm) in t of attenuation and reduction in weight, and through further experiments, it was confirmed that the average diameter (mm) of the plurality of wires constituting the conductor wire is preferably configured to be 0.166 to 0.174 millimeters (mm) in consideration of margins, measurement errors, or the like.

Meanwhile, as the collective pitch or the length of the conductor according to the collective pitch of the four conductor wires 20 completed according to Example 1 increases, the communication characteristics are degraded by near end crosstalk. Here, the near end crosstalk (NEXT) means a phenomenon where electrostatic coupling or electromagnetic coupling occurs between adjacent conductors, which causes signal current from one conductor to be induced into another conductor, generating noise or signal interference.

In particular, the Ethernet cable 100 for a vehicle of the present disclosure, which transmits LVDS signals, needs to have attenuation characteristics and minimize electromagnetic interference (EMI) according to crosstalk between adjacent pairs inside the cable. Accordingly, the present inventors, with reference to TIA EIA 644 A, which is an LVDS system standard defined by the Electronic Industries Association of the United States, and the Open Alliance, which is an Ethernet system standard for a vehicle, have adjusted the collective pitch of the four conductor wires 20 so that the near end crosstalk of a transmission section of 100 meters (m) of the Ethernet cable 100 for a vehicle for a 50 MHz test signal is 50 dB or more. Similarly, an actual measured value of the attenuation according to the aforementioned measurement method is measured with a negative sign, but an attenuation value measured in the present disclosure is expressed with a positive sign because the standard above indicates a positive sign for the same value.

As illustrated in FIG. 3, as a result of measuring the near end crosstalk (NEXT) according to the collective pitch of the Ethernet cable manufactured according to Example 1, it was confirmed that the range of the collective pitch for which the near end crosstalk of the cable is satisfied to be 50 dB or more is approximately 34.2 mm or less. Therefore, it was confirmed that both the attenuation and near end crosstalk of the Ethernet cable 100 for a vehicle of the present disclosure may be fully satisfied with the conditions when the collective pitch of the four conductor wires 20 is configured to be approximately 26 to 34 millimeters (mm), preferably 29 to 31 millimeters (mm).

That is, when the total sum of cross-sectional areas (mm²) of the seven wires constituting each of the four conductor wires 20 is satisfied with a range of 0.15 to 0.17 mm², while the four conductor wires 20 are configured with the collective pitch of 26 to 34 millimeters (mm), the Ethernet cable 100 for a vehicle according to the present disclosure may minimize the amount of conductors used, thereby reducing manufacturing costs of the cable, while the overall outer diameter and weight of the cable are minimized, thereby improving energy efficiency and interior space efficiency of the vehicle.

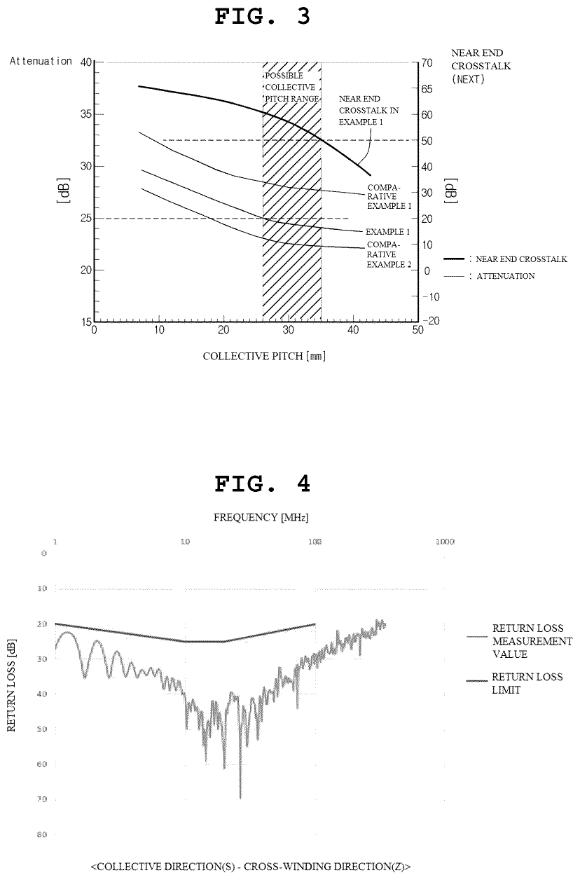

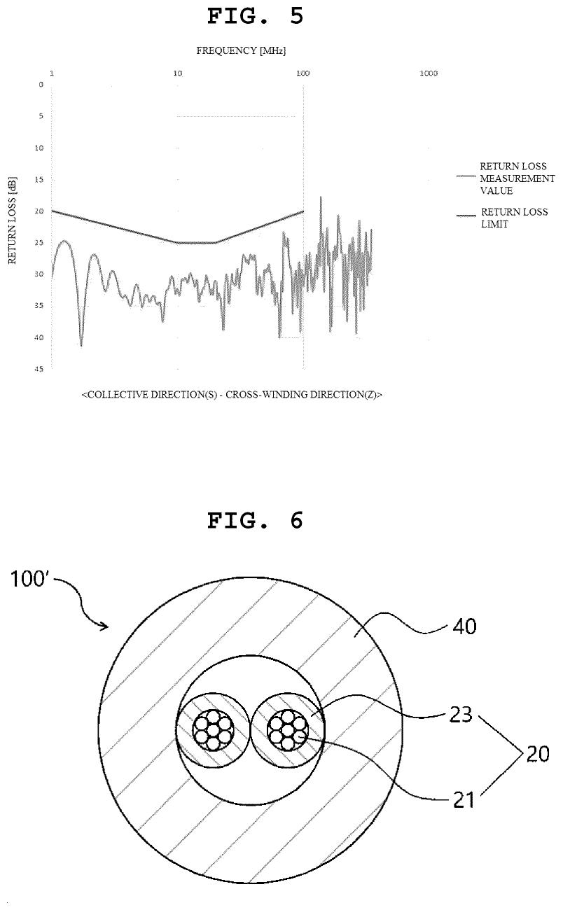

FIG. 4 illustrates a graph of measured return loss (RL) when the aluminum mylar tape layer 31 of the Ethernet cable 100 for a vehicle according to the present disclosure is cross-wound in a direction different from the collective direction of the four conductor wires 20, and FIG. 5 illustrates a graph of measured return loss when the aluminum mylar tape layer 31 of the Ethernet cable 100 for a vehicle according to the present disclosure is cross-wound in a direction identical to the collective direction of the four conductor wires 20.

Specifically, in the Ethernet cable 100 of the present disclosure for a vehicle, the return loss for each frequency (MHz) of the Ethernet cable 100 installed on a transmission line was measured by cross-winding the aluminum mylar tape layer 31 in an S direction and a Z direction, respectively, with the four conductor wires 20 assembled together in the S direction.

Here, the return loss means a degree of impedance matching between the cable and the connector. Structural return loss, which is the loss caused by small vibrations that occur according to the length of the cable, and reflection loss of an input signal occurring at a connection part of the cable (connector, patch cord, etc.) are combined and generally referred to as the return loss, and the smaller return loss value means that the reflection is smaller and the impedance matching is better.

As illustrated in FIG. 4, when the four conductor wires 20 were assembled together in the S direction and the aluminum mylar (Al-mylar) tape layer 31 was cross-wound thereon in the Z direction, the unwinding phenomenon of the aluminum mylar tape layer 31 provided on an upper portion of the four conductor wires 20 was minimized and the internal structure was maintained in a stable state, so that the return loss value was measured to be relatively small.

In addition, when the aluminum mylar tape layer 31 is cross-wound in a direction different from the collective direction of the four conductor wires 20, it can be seen that the measured return loss value may have a sufficient margin over a return loss limit (RL Limit) in all test frequency (MHZ) ranges.

Here, the return loss limit is a value experimentally derived for the return loss of the Ethernet cable 100 for a vehicle, and when the measured return loss value is greater than the RL Limit, the connection part of the Ethernet cable may be damaged, or the data transmission rate may be reduced, resulting in an overall degradation of the performance of the LVDS system.

In contrast, as illustrated in FIG. 5, when the four conductor wires 20 were assembled together in the S direction and the aluminum mylar (Al-mylar) tape was cross-wound thereon in the S direction, various mechanical stresses, such as stresses, tensile forces, and the like, applied to the four conductor wires 20 by flexing or bending of the cable were concentrated in a specific area of the conductor wires 20 according to the cross-winding direction of the aluminum mylar tape layer 31, resulting in degradation of the communication characteristics. Specifically, as a result of the return loss measurement, it is believed that there is a small margin for the return loss limit in a frequency range of approximately 80 to 100 MHz, or that the return loss value exceeds the return loss limit in a high frequency area, resulting in data loss, poor signal, and the like according to impedance mismatch.

Therefore, in the Ethernet cable 100 for a vehicle according to the present disclosure, it was confirmed that the return loss characteristic among the electrical characteristics of the cable may be improved by the collective direction of the four conductor wires 20 being configured to be different from the cross-winding direction of the aluminum mylar tape layer 31.

While the present disclosure has been described above with reference to the exemplary embodiments, it may be understood by those skilled in the art that the present disclosure may be variously modified and changed without departing from the spirit and scope of the present disclosure disclosed in the claims. Therefore, it should be understood that any modified embodiment that essentially includes the constituent elements of the claims of the present disclosure is included in the technical scope of the present disclosure.

1. An Ethernet cable for a vehicle comprising:
a filler member; and
four conductor wires disposed around the filler member and configured to include a plurality of wires having a total sum of cross-sectional areas of 0.15 to 0.17 millimeters (mm²) and an insulator surrounding the plurality of wires;
wherein the four conductor wires are configured to be assembled together at a collective pitch of 26 to 34 millimeters (mm); and
wherein the four conductor wires are configured in pairs of two, each pair of the four conductor wires being capable of transmission for different low voltage differential signaling (LVDS).

2. The Ethernet cable of claim 1, wherein the collective pitch of the four conductor wires is preferably 29 to 31 millimeters (mm).

3. The Ethernet cable of claim 1, wherein an attenuation per unit length (m) of the cable for a 50 MHz test signal is 0.25 dB or less.

4. The Ethernet cable of claim 1, wherein a near end crosstalk over a transmission section of 100 meters (m) of the cable for a 50 MHz test signal is 50 dB or more.

5. The Ethernet cable of claim 1, wherein the plurality of wires constituting the four conductor wires have an average diameter of 0.16 to 0.18 millimeters (mm).

6. The Ethernet cable of claim 1, wherein each of the four conductor wires is configured with seven wires, and
wherein the seven wires are configured such that one wire is disposed in the center and six wires are disposed to be circumscribed therearound.

7. The Ethernet cable of claim 6, wherein the insulator of the four conductor wire is configured to have a thickness of 0.3 to 0.6 millimeters (mm) and has a characteristic impedance of 90 to 110 ohms (Ω) for a 50 MHz test signal.

8. The Ethernet cable of claim 1, wherein the filler member is made of at least one material of polyethylene (PE), fluorinated ethylene propylene (FEP), or polyethylene terephthalate (PET), and has an outer diameter of 0.5 to 0.6 millimeters (mm).

9. The Ethernet cable of claim 7, wherein each of the four conductor wires has an outer diameter of 1.3 to 1.7 millimeters (mm).

10. The Ethernet cable of claim 1, wherein the cable has an outer diameter of 4.5 to 6.0 millimeters (mm).

11. The Ethernet cable of claim 1, further comprising:
a shielding layer surrounding the four conductor wires,
wherein the shielding layer includes an aluminum mylar (Al-mylar) tape layer.

12. The Ethernet cable of claim 11, wherein the shielding layer includes a braided layer configured to include at least one of tinned copper or carbon fiber surrounding the aluminum mylar (Al-mylar) tape layer.

13. The Ethernet cable of claim 11, wherein the aluminum mylar (Al-mylar) tape layer is cross-wound in a direction different from a collective direction of the four conductor wires.

14. The Ethernet cable of claim 11, further comprising:
an outer jacket surrounding the shielding layer.
